(19) United States
(12) Patent Application Publication
(10) Pub. No.: US 2026/0154038 A1
(43) Pub. Date: Jun. 4, 2026

(54) SYSTEM AND METHOD FOR MANAGING INPUT DATA COMPATIBILITY WITH A SOFTWARE APPLICATION

(71) Applicant: The Toronto-Dominion Bank, Toronto (CA)

(72) Inventors: Senthil Muthukumaran SELVARAJ, Oakville (CA); Ivan CHAN, Toronto (CA); Srinivasan SARMAN, Oakville (CA); Aayush KATHURIA, Brampton (CA)

(21) Appl. No.: 18/965,537

(22) Filed: Dec. 2, 2024

(51) Int. Cl. G06F 7/78; G06F 7/02

(52) U.S. Cl. CPC G06F 7/78; G06F 7/02

(57) ABSTRACT

Computing platforms, methods, and storage media for managing input data compatibility with a software application are disclosed. Exemplary implementations may: receive an input file having input data content arranged according to a first data format; compare the input data content with expected data content in relation to which the software application has been configured; compare the first data format with an expected data format in relation to which the software application has been configured; in response to determination that the input data content substantially overlaps with the expected data content and the first data format differs from the expected data format: generate a rearranged input file by rearranging the input data content according to the expected data format; and provide the rearranged input file to the software application for processing. Exemplary implementations avoid processing incompatibility and errors while avoiding the need to reconfigure the application.

### FIELD

The present disclosure relates to software and data communications, including but not limited to computing platforms, methods, and storage media for managing input data compatibility with a software application.

### BACKGROUND

In data and computer communications, a software application may be configured to process an input file. The input file may have a first data format, and the application may be configured to process the input file based on the first data format.

Over time, software and data may go through a number of different iterations and revisions. As part of these revisions, a data format of an input file may be modified so that it has a second data format, which is different from but possibly similar to the first data format. In such a case, the application will not be able to properly process the input file based on the original configuration, which is based on the first data format and not the second data format.

Improvements in approaches for managing input data compatibility with a software application are desirable.

### BRIEF DESCRIPTION OF THE DRAWINGS

Embodiments of the present disclosure will now be described, by way of example only, with reference to the attached Figures.

FIG. 1 illustrates a method for managing input data compatibility with a software application, in accordance with one or more embodiments.

FIG. 2 illustrates a system configured for managing input data compatibility with a software application, in accordance with one or more embodiments.

FIG. 3 illustrates a method for managing input data compatibility with a software application, in accordance with one or more embodiments.

### DETAILED DESCRIPTION

Computing platforms, methods, and storage media for managing input data compatibility with a software application are disclosed. Exemplary implementations may: receive an input file having input data content arranged according to a first data format; compare the input data content with expected data content in relation to which the software application has been configured; compare the first data format with an expected data format in relation to which the software application has been configured; in response to determination that the input data content substantially overlaps with the expected data content and the first data format differs from the expected data format: generate a rearranged input file by rearranging the input data content according to the expected data format; and provide the rearranged input file to the software application for processing. Exemplary implementations avoid processing incompatibility and errors while avoiding the need to reconfigure the application.

The present disclosure provides a platform to change an input data format of a received input file to match an expected data format in relation to which an application was configured.

In accordance with one or more embodiments, a system is provided to manage changes in a data format of a file to be used by an application. When the application has been configured with respect to a first data format, and an input file has a second data format, the system modifies the input file in the second data format to be in the first data format that is expected by the application. In this way, even if an input file format has changed, the application may process the input file based on an existing configuration, for example when the input file data content sufficiently overlaps with expected data content. The system may check to see if the input file has a data format that matches the data format expected in the configuration file, and modify the input file only when the data format does not match. This provides the advantage of application flexibility without having to modify the application itself, when an input file data format has changed compared to an original configuration.

One aspect of the present disclosure relates to an apparatus or a computing platform configured for managing input data compatibility with a software application. The apparatus or computing platform may include a non-transient computer-readable storage medium having executable instructions embodied thereon. The apparatus or computing platform may include one or more hardware processors configured to execute the instructions. The processor(s) may execute the instructions to receive an input file having input data content arranged according to a first data format. The processor(s) may execute the instructions to compare the input data content with expected data content in relation to which the software application has been configured. The processor(s) may execute the instructions to compare the first data format with an expected data format in relation to which the software application has been configured. The processor(s) may execute the instructions to, in response to determination that the input data content substantially overlaps with the expected data content and the first data format differs from the expected data format, generate a rearranged input file by rearranging the input data content according to the expected data format. The processor(s) may execute the instructions to provide the rearranged input file to the software application for processing.

Another aspect of the present disclosure relates to a method of managing input data compatibility with a software application. The method may include receiving an input file having input data content arranged according to a first data format. The method may include comparing the input data content with expected data content in relation to which the software application has been configured. The method may include comparing the first data format with an expected data format in relation to which the software application has been configured. The method may include, in response to determination that the input data content substantially overlaps with the expected data content and the first data format differs from the expected data format, generating a rearranged input file by rearranging the input data content according to the expected data format. The method may include providing the rearranged input file to the software application for processing.

Yet another aspect of the present disclosure relates to a non-transient computer-readable storage medium having instructions embodied thereon, the instructions being executable by one or more processors to perform a method of managing input data compatibility with a software application. The method may include receiving an input file having input data content arranged according to a first data format. The method may include comparing the input data content with expected data content in relation to which the software application has been configured. The method may include comparing the first data format with an expected data format in relation to which the software application has been configured. The method may include, in response to determination that the input data content substantially overlaps with the expected data content and the first data format differs from the expected data format, generating a rearranged input file by rearranging the input data content according to the expected data format. The method may include providing the rearranged input file to the software application for processing.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Embodiments of the present disclosure provide a system that enables a software application to process an input file having a second data format, when the application was configured to process the input file based on a first data format.

According to a known approach, if an application receives an input file in a data format different from the data format that is expected, the application may still process the input file. However, since the data format is different than what is expected, the output of the processing will be incorrect, and the processing may not even complete properly. One issue with such situations is that, without being able to know if the input file data format has changed, the software application may process the input file according to the expected data format configuration. If there are no obvious errors, the application may inadvertently provide erroneous output results, without any indication or notification that there may be anything wrong with the output results. This can result in a user of the application relying on data that is unreliable and erroneous, without any error indication or warning.

According to another known approach, if may be possible to identify that an input file data format is different from what was expected by the application. This may be, for example, in response to detection of an error or a report of an erroneous output result, and optionally in response to an indication that there are no errors in the operation of the application itself.

One solution for addressing these issues is to reconfigure the software application so that it can process the input file based on the second data format, rather than the first data format based on which it was originally configured. However, this involves a significant application reconfiguration effort, as well as taking the application offline, or making other arrangements, during reconfiguration. This also involves separate reconfiguration each time a data format differs from an expected data format.

There is a technical problem associated with known approaches in that an input data file with a format that differs from an expected data format will cause a software application to operate improperly and/or inaccurately. There is a further technical problem that an input data file with an incompatible data format, compared to an expected data format in relation to which the application has been configured, would require modification of the application itself. Embodiments of the present disclosure provide a technical solution by determining whether an input data file has a data format that matches the expected data format. If the data formats do not match, and if some or all of the data content matches or overlaps, one or more embodiments of the present disclosure rearrange the input data according to the expected data format, and provide a modified input file to the application for processing. This technical solution avoids errors caused by processing an input file with an unexpected or improper data format, and avoids the need to reconfigure the application in order to be able to process an input file with an unexpected input data format in relation to which it has not been configured.

Embodiments of the present disclosure solve a problem in a scenario where an application has an existing configuration, and an input file is not in the expected data format and where the input data content substantially overlap with or match the expected data content. For example, the input data file may have fields in different file locations than expected in the configuration file. In an implementation, the application may only want certain fields, or want to shuffle fields around, remove fields or add fields. Embodiments of the present disclosure avoid the need to change the application or process itself, which is advantageous since it has already been configured, and it is desirable not to have to reconfigure the application.

In accordance with one or more embodiments of the present disclosure, a system or method determine positions of data fields in a delimited input file. The system may be configured to shuffle a data field from a first position to a second position in response to an indication or determination that the input data format is different from an expected input data format.

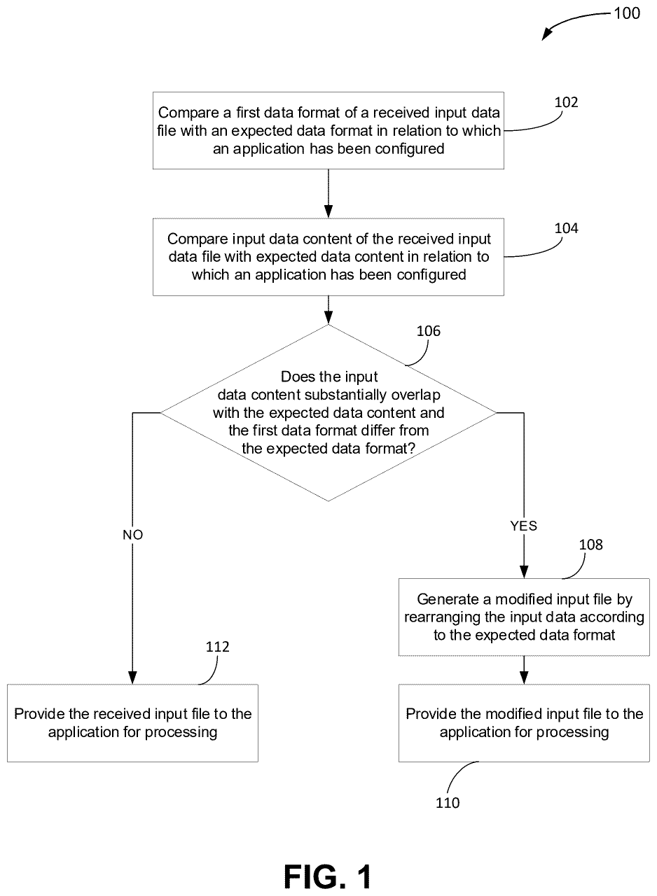

FIG. 1 illustrates a method 100 for managing input data compatibility with a software application, in accordance with one or more embodiments. After receiving an input data file having input data content arranged according to a first data format, at 102, the first data format is compared with an expected data format in relation to which an application has been configured. At 102, the method performs a data format comparison. At 104, the input data content is compared with expected data content in relation to which an application has been configured. At 104, the method performs a data content comparison. At 106, a determination is made whether the input data content substantially overlaps with the expected data content and the first data format differs from the expected data format.

In an embodiment, the determination at 106 may result in “yes” if the input data content sufficiently overlaps with the expected data content to enable proper operation of the software application. For example, if proper operation of the software application relies on the expected data content comprising core data content (in addition to optional data content), the determination at 106 may result in “yes” if the input data content comprises the core data content from the expected data content. In an embodiment, the determination at 106 may result in “yes” if the input data content matches the expected data content. Matching the expected data content may comprise matching the core data content, or matching portions of the expected data content that are necessary for proper operation of the software application and/or for proper operation of one or more functions of the software application.

If the determination in 106 is yes, the method at 108 generates a modified input file by rearranging the input data according to the expected data format. At 110, the modified input file is then provided to the application for processing, without requiring any modification of the application. At this point, the input data content has been rearranged into the expected data format, ensuring that the application will properly process the input data file. If the first data format does not differ from the expected data format, then at 112 the input data file as received is provided to the application for processing, since it is already in the proper format.

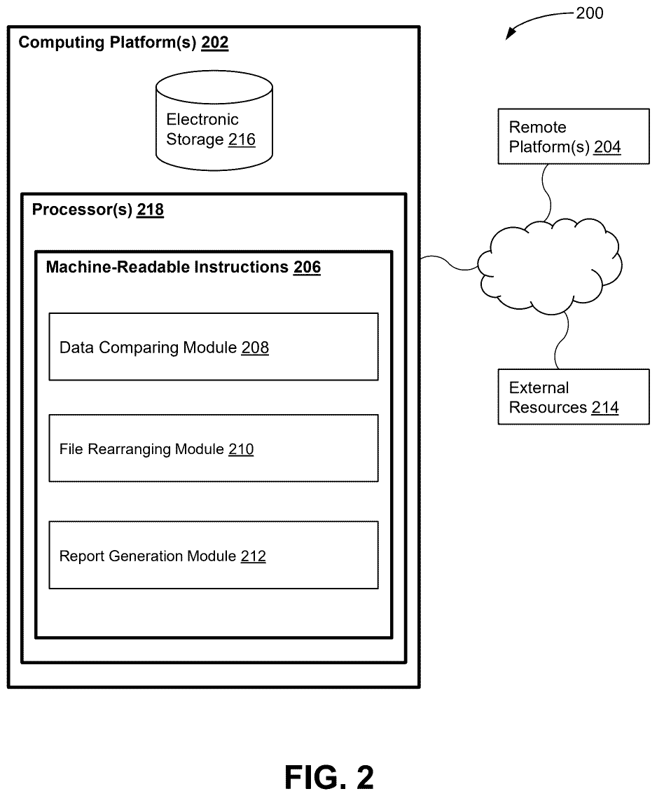

FIG. 2 illustrates a system 200 configured for managing input data compatibility with a software application, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of data comparing module 208, file rearranging module 210, report generation module 212, and/or other instruction modules.

A data comparator, such as data comparing module 208, may be configured to receive an input file having input data content arranged according to a first data format. Data comparing module 208 may be configured to compare the input data content with expected data content in relation to which the software application has been configured.

Data comparing module 208 may be configured to compare the first data format with an expected data format in relation to which the software application has been configured. Data comparing module 208 may be configured to determine that the first data format differs from the expected data format based on the input data including, with respect to the expected data format, one or more of: a new column, removal of an existing column, a column in a different position. Data comparing module 208 may be configured to compare an arrangement of the input data in the first data format according to a first plurality of data columns to a second plurality of columns in the expected data format. Determining that the first data format differs from the expected data format may include determining that the first data format differs from the expected data format based on a detected difference between the first plurality of data columns and the second plurality of data columns.

Data comparing module 208 may be configured to determine that the input data content substantially overlaps with the expected data content and the first data format differs from the expected data format. Data comparing module 208 may be configured to determine that the input data content substantially overlaps with the expected data content when the input data content matches the expected data content. Data comparing module 208 may be configured to generate a data comparison result, and to provide the data comparison result to file rearranging module 210.

A file rearranger, such as file rearranging module 210, may be configured to, in response to determination that the input data content substantially overlaps with the expected data content and the first data format differs from the expected data format: generate a rearranged input file by rearranging the input data content according to the expected data format; and provide the rearranged input file to the software application for processing. Generating the rearranged input file may include generating the rearranged input file in response to determination that the input data content sufficiently overlaps with the expected data content to enable proper operation of the software application. Generating the rearranged input file may include generating the rearranged input file in response to determination that the input data content matches the expected data content.

With respect to file rearranging module 210, generating the rearranged input file may include generating the rearranged input file by rearranging the input data content independent of any modification of the input data content. Generating the rearranged input file may include generating the rearranged input file by rearranging the input data content independent of any conversion of the input data content. Generating the rearranged input file may include generating the rearranged input file by rearranging the input data content independent of any translation of the input data content.

With respect to file rearranging module 210, generating the rearranged input file may include generating the rearranged input file by shuffling a data field of the input data content from a first position to a second position. Generating the rearranged input file may include generating the rearranged input file by moving a column of the input data content without modifying the input data content within the column.

A report generator, such as report generation module 212, may be configured to generate a modified column report indicating columns that are: newly introduced into the file, or are absent, or are in a different position, when comparing the first data format with the expected data format.

In some embodiments, computing platform(s) 202, remote platform(s) 204, and/or external resources 214 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 214 may be operatively linked via some other communication media.

A given remote platform 204 may include one or more processors configured to execute computer program modules. The computer program modules may be configured to enable an expert or user associated with the given remote platform 204 to interface with system 200 and/or external resources 214, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 214 may include sources of information outside of system 200, external entities participating with system 200, and/or other resources. In some embodiments, some or all of the functionality attributed herein to external resources 214 may be provided by resources included in system 200.

Computing platform(s) 202 may include electronic storage 216, one or more processors 218, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 216 may comprise non-transitory storage media that electronically stores information. The electronic storage media of electronic storage 216 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 216 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 216 may include one or more virtual storage resources (e.g., cloud storage, a virtual private network, and/or other virtual storage resources). Electronic storage 216 may store software algorithms, information determined by processor(s) 218, information received from computing platform(s) 202, information received from remote platform(s) 204, and/or other information that enables computing platform(s) 202 to function as described herein.

Processor(s) 218 may be configured to provide information processing capabilities in computing platform(s) 202. As such, processor(s) 218 may include one or more of a digital processor, an analog processor, a digital circuit designed to process information, an analog circuit designed to process information, a state machine, and/or other mechanisms for electronically processing information. Although processor(s) 218 is shown in FIG. 2 as a single entity, this is for illustrative purposes only. In some embodiments, processor(s) 218 may include a plurality of processing units. These processing units may be physically located within the same device, or processor(s) 218 may represent processing functionality of a plurality of devices operating in coordination. Processor(s) 218 may be configured to execute modules 208, 210 and/or 212, and/or other modules. Processor(s) 218 may be configured to execute modules 208, 210 and/or 212, and/or other modules by software; hardware; firmware; some combination of software, hardware, and/or firmware; and/or other mechanisms for configuring processing capabilities on processor(s) 218. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210 and/or 212 are illustrated in FIG. 2 as being implemented within a single processing unit, in embodiments in which processor(s) 218 includes multiple processing units, one or more of modules 208, 210 and/or 212 may be implemented remotely from the other modules. The description of the functionality provided by the different modules 208, 210 and/or 212 described below is for illustrative purposes, and is not intended to be limiting, as any of modules 208, 210 and/or 212 may provide more or less functionality than is described. For example, one or more of modules 208, 210 and/or 212 may be eliminated, and some or all of its functionality may be provided by other ones of modules 208, 210 and/or 212. As another example, processor(s) 218 may be configured to execute one or more additional modules that may perform some or all of the functionality attributed below to one of modules 208, 210 and/or 212.

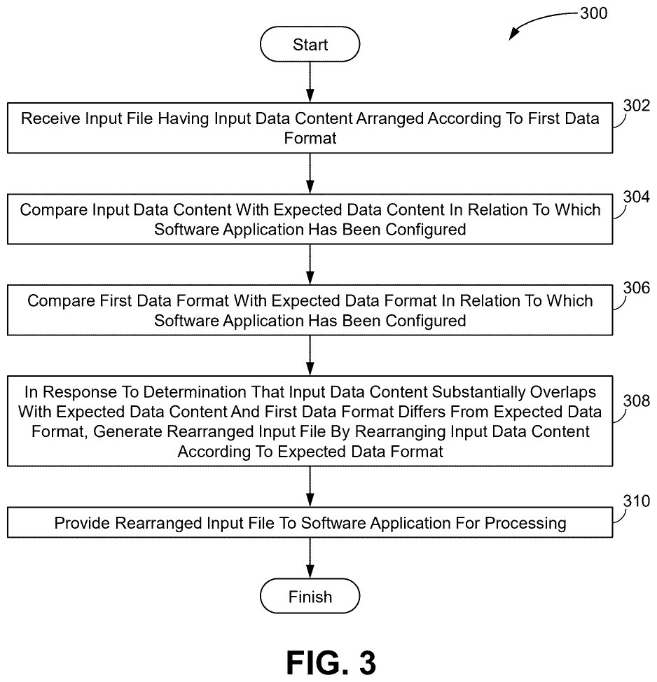

FIG. 3 illustrates a method 300 for managing input data compatibility with a software application, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving an input file having input data content arranged according to a first data format. Operation 302 may be performed by one or more hardware processors configured by machine-readable instructions including a module that is the same as or similar to module 208, in accordance with one or more embodiments.

An operation 304 may include comparing the input data content with expected data content in relation to which the software application has been configured. Operation 304 may be performed by one or more hardware processors configured by machine-readable instructions including a module that is the same as or similar to module 208, in accordance with one or more embodiments.

An operation 306 may include comparing the first data format with an expected data format in relation to which the software application has been configured. Operation 306 may be performed by one or more hardware processors configured by machine-readable instructions including a module that is the same as or similar to module 208, in accordance with one or more embodiments.

An operation 308 may include, in response to determination that the input data content substantially overlaps with the expected data content and the first data format differs from the expected data format, generating a rearranged input file by rearranging the input data content according to the expected data format. Operation 308 may be performed by one or more hardware processors configured by machine-readable instructions including a module that is the same as or similar to module 210, in accordance with one or more embodiments.

An operation 310 may include providing the rearranged input file to the software application for processing. Operation 310 may be performed by one or more hardware processors configured by machine-readable instructions including a module that is the same as or similar to module 210, in accordance with one or more embodiments.

One or more embodiments of the present disclosure may be configured to modify an input file data schema to be consistent with an expected data schema or data format, to avoid the need to make changes in or to the application. The system may rearrange the input data into the format that is expected according to a configuration file. For example, in production, a 10th column of the input data file may be moved to the 2nd position. The system may be configured to shuffle the input data file format so that the data expected at the 10^{th} column is moved to the 10^{th} column, if it is not already in the 10^{th} column. The system may change the data back to a known or expected format, so that it is not necessary to rewrite the application. The system may be configured for use with respect to any delimiter, such as with any type of delimited file.

If an input data format has changed subsequent to an application being configured, one or more embodiments of the present disclosure may be configured to change the input data format of an input file so that it matches the expected data format. This step is taken prior to the input file being input to the application, so that the application can use the same configuration with the differently formatted data being modified or rearranged before input.

In an embodiment, the system obtains a baseline version of the data format that is expected, and obtains or detects a data format of the actual file that needs to be processed. According to this approach, the system does not use the input file with its existing data format or layout, but the input file will be modified or shuffled to match the baseline version schema, or expected data format.

The system may be configured to compare an input file format with an expected data format. If the data formats match, and if the input data content substantially overlaps with the expected data content, then the system may proceed to process the input file. If the data formats do not match, and if the input data content substantially overlaps with the expected data content, the system may be used to convert the received data format to the expected data format. The system may be configured to automatically obtain or detect the data format.

Application teams often make changes. Using embodiments of the present disclosure means that an application does not need to be reconfigured even if the application team makes changes to the input data format, but still expects substantially overlapping data content.

A file shuffler according to one or more embodiments of the present disclosure may be executed if received data is in a different format than an expected format and comprises data content that substantially overlaps with expected data content. The system may be configured to modify the file and to create a new file. If the file format matches, no rearrangement or shuffling is required.

After a specified time period, the system may be configured to generate a report indicating the new fields that came in via one or more input files, where the new fields are not included in the expected configuration. The system may be configured to generate a configuration notification, which can be used to determine whether to modify a configuration, for the new fields.

One or more embodiments of the present disclosure may be used on a configuration level, for any number of files, any number of fields. The system will not generate an application failure, but will generate a report.

With respect to a comparison of a received data format to an expected data format, the system may be configured to generate a report indicating the number of columns that are newly introduced into the file, or are absent, or are in a different position.

An input file may be determined to have a different data format than an expected data format if it includes one or more of: a new column, removal of an existing column, a column in a different position.

A file shuffler according to one or more embodiments of the present disclosure works on a data level. And it can be used for multiple files in a single run, in different folders. Embodiments of the present disclosure may provide an input to a control file, and may take care of files of different formats.

One or more embodiments of the present disclosure provide a platform to change an input data format of a received input file to match an expected data format in relation to which an application was configured, when received data content substantially overlaps with expected data content. The system may be configured to modify an input file in a second data format to be in a first data format that is expected by the application. If an input file format has changed, the application may still process the input file based on an existing configuration. The system may verify whether the input file has a data format that matches the data format expected in the configuration file, and modify the input file only when the data format does not match. This provides an advantage of application flexibility without having to modify the application itself, when an input file data format has changed compared to an original configuration.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the CLAIMS appended hereto.

Embodiments of the disclosure can be described with reference to the following clauses, with specific features laid out in the dependent clauses:
One aspect of the present disclosure relates to a system configured for managing input data compatibility with a software application. The system may include one or more hardware processors configured by machine-readable instructions. The processor(s) may be configured to receive an input file having input data content arranged according to a first data format. The processor(s) may be configured to compare the input data content with expected data content in relation to which the software application has been configured. The processor(s) may be configured to compare the first data format with an expected data format in relation to which the software application has been configured. The processor(s) may be configured, in response to determination that the input data content substantially overlaps with the expected data content and the first data format differs from the expected data format, to generate a rearranged input file by rearranging the input data content according to the expected data format. The processor(s) may be configured to provide the rearranged input file to the software application for processing.

In some implementations of the system, the processor(s) may be configured to generate the rearranged input file in response to determination that the input data content sufficiently overlaps with the expected data content to enable proper operation of the software application.

In some implementations of the system, the processor(s) may be configured to generate the rearranged input file in response to determination that the input data content matches the expected data content.

In some implementations of the system, the processor(s) may be configured to generate the rearranged input file by rearranging the input data content independent of any modification of the input data content.

In some implementations of the system, the processor(s) may be configured to generate the rearranged input file by rearranging the input data content independent of any conversion of the input data content.

In some implementations of the system, the processor(s) may be configured to generate the rearranged input file by rearranging the input data content independent of any translation of the input data content.

In some implementations of the system, the processor(s) may be configured to generate the rearranged input file by shuffling a data field of the input data content from a first position to a second position.

In some implementations of the system, the processor(s) may be configured to generate the rearranged input file by moving a column of the input data content without modifying the input data content within the column.

In some implementations of the system, the processor(s) may be configured to determine that the first data format differs from the expected data format based on the input data including, with respect to the expected data format, one or more of: a new column, removal of an existing column, a column in a different position.

In some implementations of the system, the processor(s) may be configured to compare an arrangement of the input data in the first data format according to a first plurality of data columns to a second plurality of columns in the expected data format. In some implementations of the system, the processor(s) may be configured to determine that the first data format differs from the expected data format based on a detected difference between the first plurality of data columns and the second plurality of data columns.

In some implementations of the system, the processor(s) may be configured to generate a modified column report indicating columns that are: newly introduced into the file, or are absent, or are in a different position, when comparing the first data format with the expected data format.

Another aspect of the present disclosure relates to a processor-implemented method of managing input data compatibility with a software application. The method may include receiving an input file having input data content arranged according to a first data format. The method may include comparing the input data content with expected data content in relation to which the software application has been configured. The method may include comparing the first data format with an expected data format in relation to which the software application has been configured. The method may include, in response to determination that the input data content substantially overlaps with the expected data content and the first data format differs from the expected data format, generating a rearranged input file by rearranging the input data content according to the expected data format. The method may include providing the rearranged input file to the software application for processing.

In some implementations of the method, it may include generating the rearranged input file in response to determination that the input data content sufficiently overlaps with the expected data content to enable proper operation of the software application.

In some implementations of the method, it may include generating the rearranged input file in response to determination that the input data content matches the expected data content.

In some implementations of the method, it may include generating the rearranged input file by rearranging the input data content independent of any modification of the input data content.

In some implementations of the method, it may include generating the rearranged input file by rearranging the input data content independent of any conversion of the input data content.

In some implementations of the method, it may include generating the rearranged input file by rearranging the input data content independent of any translation of the input data content.

In some implementations of the method, it may include generating the rearranged input file by shuffling a data field of the input data content from a first position to a second position.

In some implementations of the method, it may include generating the rearranged input file by moving a column of the input data content without modifying the input data content within the column.

In some implementations of the method, it may include determining that the first data format differs from the expected data format based on the input data including, with respect to the expected data format, one or more of: a new column, removal of an existing column, a column in a different position.

In some implementations of the method, it may include comparing an arrangement of the input data in the first data format according to a first plurality of data columns to a second plurality of columns in the expected data format. In some implementations of the method, it may include determining that the first data format differs from the expected data format based on a detected difference between the first plurality of data columns and the second plurality of data columns.

In some implementations of the method, it may include generating a modified column report indicating columns that are: newly introduced into the file, or are absent, or are in a different position, when comparing the first data format with the expected data format.

Yet another aspect of the present disclosure relates to a non-transient computer-readable storage medium having instructions embodied thereon, the instructions being executable by one or more processors to perform a method of managing input data compatibility with a software application. The method may include receiving an input file having input data content arranged according to a first data format. The method may include comparing the input data content with expected data content in relation to which the software application has been configured. The method may include comparing the first data format with an expected data format in relation to which the software application has been configured. The method may include, in response to determination that the input data content substantially overlaps with the expected data content and the first data format differs from the expected data format, generating a rearranged input file by rearranging the input data content according to the expected data format. The method may include providing the rearranged input file to the software application for processing.

In some implementations of the computer-readable storage medium, the method may include generating the rearranged input file in response to determination that the input data content sufficiently overlaps with the expected data content to enable proper operation of the software application.

In some implementations of the computer-readable storage medium, the method may include generating the rearranged input file in response to determination that the input data content matches the expected data content.

In some implementations of the computer-readable storage medium, the method may include generating the rearranged input file by rearranging the input data content independent of any modification of the input data content.

In some implementations of the computer-readable storage medium, the method may include generating the rearranged input file by rearranging the input data content independent of any conversion of the input data content.

In some implementations of the computer-readable storage medium, the method may include generating the rearranged input file by rearranging the input data content independent of any translation of the input data content.

In some implementations of the computer-readable storage medium, the method may include generating the rearranged input file by shuffling a data field of the input data content from a first position to a second position.

In some implementations of the computer-readable storage medium, the method may include generating the rearranged input file by moving a column of the input data content without modifying the input data content within the column.

In some implementations of the computer-readable storage medium, the method may include determining that the first data format differs from the expected data format based on the input data including, with respect to the expected data format, one or more of: a new column, removal of an existing column, a column in a different position.

In some implementations of the computer-readable storage medium, the method may include comparing an arrangement of the input data in the first data format according to a first plurality of data columns to a second plurality of columns in the expected data format. In some implementations of the computer-readable storage medium, the method may include determining that the first data format differs from the expected data format based on a detected difference between the first plurality of data columns and the second plurality of data columns.

In some implementations of the computer-readable storage medium, the method may include generating a modified column report indicating columns that are: newly introduced into the file, or are absent, or are in a different position, when comparing the first data format with the expected data format.

Still another aspect of the present disclosure relates to a system configured for managing input data compatibility with a software application. The system may include means for receiving an input file having input data content arranged according to a first data format. The system may include means for comparing the input data content with expected data content in relation to which the software application has been configured. The system may include means for comparing the first data format with an expected data format in relation to which the software application has been configured. The system may include means for, in response to determination that the input data content substantially overlaps with the expected data content and the first data format differs from the expected data format, generating a rearranged input file by rearranging the input data content according to the expected data format. The system may include means for providing the rearranged input file to the software application for processing.

In some implementations of the system, the system may include means for generating the rearranged input file in response to determination that the input data content sufficiently overlaps with the expected data content to enable proper operation of the software application.

In some implementations of the system, the system may include means for generating the rearranged input file in response to determination that the input data content matches the expected data content.

In some implementations of the system, the system may include means for generating the rearranged input file by rearranging the input data content independent of any modification of the input data content.

In some implementations of the system, the system may include means for generating the rearranged input file by rearranging the input data content independent of any conversion of the input data content.

In some implementations of the system, the system may include means for generating the rearranged input file by rearranging the input data content independent of any translation of the input data content.

In some implementations of the system, the system may include means for generating the rearranged input file by shuffling a data field of the input data content from a first position to a second position.

In some implementations of the system, the system may include means for generating the rearranged input file by moving a column of the input data content without modifying the input data content within the column.

In some implementations of the system, the system may include means for determining that the first data format differs from the expected data format based on the input data including, with respect to the expected data format, one or more of: a new column, removal of an existing column, a column in a different position.

In some implementations of the system, the system may include means for comparing an arrangement of the input data in the first data format according to a first plurality of data columns to a second plurality of columns in the expected data format. In some implementations of the system, the system may include means for determining that the first data format differs from the expected data format based on a detected difference between the first plurality of data columns and the second plurality of data columns.

In some implementations of the system, the system may include means for generating a modified column report indicating columns that are: newly introduced into the file, or are absent, or are in a different position, when comparing the first data format with the expected data format.

Even another aspect of the present disclosure relates to a computing platform configured for managing input data compatibility with a software application. The computing platform may include a non-transient computer-readable storage medium having executable instructions embodied thereon. The computing platform may include one or more hardware processors configured to execute the instructions. The processor(s) may execute the instructions to receive an input file having input data content arranged according to a first data format. The processor(s) may execute the instructions to compare the input data content with expected data content in relation to which the software application has been configured. The processor(s) may execute the instructions to compare the first data format with an expected data format in relation to which the software application has been configured. The processor(s) may execute the instructions, in response to determination that the input data content substantially overlaps with the expected data content and the first data format differs from the expected data format, to generate a rearranged input file by rearranging the input data content according to the expected data format. The processor(s) may execute the instructions to provide the rearranged input file to the software application for processing.

In some implementations of the computing platform, the processor(s) may execute the instructions to generate the rearranged input file in response to determination that the input data content sufficiently overlaps with the expected data content to enable proper operation of the software application.

In some implementations of the computing platform, the processor(s) may execute the instructions to generate the rearranged input file in response to determination that the input data content matches the expected data content.

In some implementations of the computing platform, the processor(s) may execute the instructions to generate the rearranged input file by rearranging the input data content independent of any modification of the input data content.

In some implementations of the computing platform, the processor(s) may execute the instructions to generate the rearranged input file by rearranging the input data content independent of any conversion of the input data content.

In some implementations of the computing platform, the processor(s) may execute the instructions to generate the rearranged input file by rearranging the input data content independent of any translation of the input data content.

In some implementations of the computing platform, the processor(s) may execute the instructions to generate the rearranged input file by shuffling a data field of the input data content from a first position to a second position.

In some implementations of the computing platform, the processor(s) may execute the instructions to generate the rearranged input file by moving a column of the input data content without modifying the input data content within the column.

In some implementations of the computing platform, the processor(s) may execute the instructions to determine that the first data format differs from the expected data format based on the input data including, with respect to the expected data format, one or more of: a new column, removal of an existing column, a column in a different position.

In some implementations of the computing platform, the processor(s) may execute the instructions to compare an arrangement of the input data in the first data format according to a first plurality of data columns to a second plurality of columns in the expected data format. In some implementations of the computing platform, the processor(s) may execute the instructions to determine that the first data format differs from the expected data format based on a detected difference between the first plurality of data columns and the second plurality of data columns.

In some implementations of the computing platform, the processor(s) may execute the instructions to generate a modified column report indicating columns that are: newly introduced into the file, or are absent, or are in a different position, when comparing the first data format with the expected data format.

What is claimed is:

1. An apparatus configured for managing input data compatibility with a software application, the apparatus comprising:
a non-transient computer-readable storage medium having executable instructions embodied thereon; and
one or more hardware processors configured to execute the instructions to:
receive an input file having input data content arranged according to a first data format;
compare the input data content with expected data content in relation to which the software application has been configured;
compare the first data format with an expected data format in relation to which the software application has been configured;
in response to determination that the input data content substantially overlaps with the expected data content and the first data format differs from the expected data format:
generate a rearranged input file by rearranging the input data content according to the expected data format; and
provide the rearranged input file to the software application for processing.

2. The apparatus of claim 1 wherein the one or more hardware processors are further configured to execute the instructions to:
generate the rearranged input file in response to determination that the input data content sufficiently overlaps with the expected data content to enable proper operation of the software application.

3. The apparatus of claim 1 wherein the one or more hardware processors are further configured to execute the instructions to:
generate the rearranged input file in response to determination that the input data content matches the expected data content.

4. The apparatus of claim 1 wherein the one or more hardware processors are further configured to execute the instructions to:
generate the rearranged input file by rearranging the input data content independent of any modification of the input data content.

5. The apparatus of claim 1 wherein the one or more hardware processors are further configured to execute the instructions to:
generating the rearranged input file by shuffling a data field of the input data content from a first position to a second position.

6. The apparatus of claim 1 wherein the one or more hardware processors are further configured to execute the instructions to:
generate the rearranged input file by moving a column of the input data content without modifying the input data content within the column.

7. The apparatus of claim 1 wherein the one or more hardware processors are further configured to execute the instructions to:
determine that the first data format differs from the expected data format based on the input data including, with respect to the expected data format, one or more of: a new column, removal of an existing column, a column in a different position.

8. The apparatus of claim 1 wherein the one or more hardware processors are further configured to execute the instructions to:
compare an arrangement of the input data in the first data format according to a first plurality of data columns to a second plurality of columns in the expected data format; and
determine that the first data format differs from the expected data format based on a detected difference between the first plurality of data columns and the second plurality of data columns.

9. The apparatus of claim 1 wherein the one or more hardware processors are further configured to execute the instructions to:
generate a modified column report indicating columns that are: newly introduced into the file, or are absent, or are in a different position, when comparing the first data format with the expected data format.

10. A method of managing input data compatibility with a software application comprising:
receiving an input file having input data content arranged according to a first data format;
comparing the input data content with expected data content in relation to which the software application has been configured;
comparing the first data format with an expected data format in relation to which the software application has been configured;
in response to determination that the input data content substantially overlaps with the expected data content and the first data format differs from the expected data format:
generating a rearranged input file by rearranging the input data content according to the expected data format; and
providing the rearranged input file to the software application for processing.

11. The method of claim 10 further comprising:
generating the rearranged input file in response to determination that the input data content sufficiently overlaps with the expected data content to enable proper operation of the software application.

12. The method of claim 10 further comprising:
generating the rearranged input file in response to determination that the input data content matches the expected data content.

13. The method of claim 10 further comprising:
generating the rearranged input file by rearranging the input data content independent of any modification of the input data content.

14. The method of claim 10 further comprising:
generating the rearranged input file by shuffling a data field of the input data content from a first position to a second position.

15. The method of claim 10 further comprising:
generating the rearranged input file by moving a column of the input data content without modifying the input data content within the column.

16. The method of claim 10 further comprising:
determining that the first data format differs from the expected data format based on the input data including, with respect to the expected data format, one or more of: a new column, removal of an existing column, a column in a different position.

17. The method of claim 10 further comprising:
comparing an arrangement of the input data in the first data format according to a first plurality of data columns to a second plurality of columns in the expected data format; and
determining that the first data format differs from the expected data format based on a detected difference between the first plurality of data columns and the second plurality of data columns.

18. The method of claim 10 further comprising:
generating a modified column report indicating columns that are: newly introduced into the file, or are absent, or are in a different position, when comparing the first data format with the expected data format.

19. A non-transient computer-readable storage medium having instructions embodied thereon, the instructions being executable by one or more processors to perform a method of managing input data compatibility with a software application comprising:
receiving an input file having input data content arranged according to a first data format;
comparing the input data content with expected data content in relation to which the software application has been configured;
comparing the first data format with an expected data format in relation to which the software application has been configured;
in response to determination that the input data content substantially overlaps with the expected data content and the first data format differs from the expected data format:
generating a rearranged input file by rearranging the input data content according to the expected data format; and
providing the rearranged input file to the software application for processing.

20. The non-transient computer-readable storage medium of claim 19 wherein the method further comprises:
generating the rearranged input file by rearranging the input data content independent of any modification of the input data content.
